(19) United States
(12) Patent Application Publication
(10) Pub. No.: US 2019/0316345 A1
(43) Pub. Date: Oct. 17, 2019

(54) VACUUM INSULATION PANEL

(71) Applicant: VA-Q-TEC AG, Würzburg (DE)

(72) Inventors: Roland CAPS, Kleinwallstadt (DE); Tobias BOCK, Biebelried OT Kaltensondheim (DE); Ivo NEMETZ, Würzburg (DE); Janek BINZEN, Würzburg (DE)

(21) Appl. No.: 16/343,161

(22) PCT Filed: Sep. 29, 2017
(86) PCT No.: PCT/EP2017/025275

§ 371 Date: Apr. 18, 2019

(30) Foreign Application Priority Data
Nov. 8, 2016 (DE) 20 2016 006 810.6

(51) Int. Cl. E04B 1/80; E04B 1/94; B32B 5/02; B32B 27/36; B32B 27/32; B32B 5/18; B32B 19/02; B32B 5/24; B32B 17/06

(52) U.S. Cl. CPC E04B 1/803; B32B 2307/3065; B32B 5/024; B32B 5/026; B32B 27/36; B32B 27/32; B32B 5/18; B32B 19/02; B32B 5/245; B32B 17/067; B32B 2307/7244; B32B 2307/304; B32B 2262/02; B32B 2262/101; B32B 2255/205; E04B 1/942

(57) ABSTRACT

The invention relates to a vacuum insulation panel, having a core (1) of open-pore material and having a casing (2), which encloses the core (1) tightly, completely and in a gas-tight manner on all sides, wherein the casing (2) has at least one gas-tight barrier layer (3). Said vacuum insulation panel is characterized in that the casing (2) has a protective layer (6) of a heat-resistant material in at least one region of the outer surface of the vacuum insulation panel on the outside of the barrier layer (3) or on an intermediate layer (4) located on the outside of the barrier layer (3).

The invention relates to a vacuum insulation panel with the features of the preamble of claim 1 and to an enclosure film for vacuum insulation panels with the features of the preamble of claim 11.

Vacuum insulation panels serve for the effective insulation of refrigerating and freezing equipment, the insulation of transport containers for temperature-sensitive products, for retrofitted insulation when refurbishing buildings, etc.

The main component parts of a vacuum insulation panel are a sheet-like core of open-pore material and an enclosure enclosing the core in a close-fitting, complete and gas-tight manner on all sides. This makes it possible to evacuate the space within the enclosure, and thereby bring the thermal conductivity of the vacuum insulation panel down to very low values.

There is a known vacuum insulation panel (DE 10 2010 019 074 A1) in which the enclosure has at least one gas-tight barrier layer and on the inner side of the barrier layer a sealing layer. This vacuum insulation panel has a sheet-like core of an open-pore material, a first barrier film, lying against a first main surface of the core over a large surface area, with at least one sealing layer facing the core, a second barrier film, surrounding the core on its other main surface and likewise with a sealing layer, and also a peripheral sealing seam, along which the two barrier films are sealed to one another with the aid of the sealing layers by thermal welding.

In the prior art, it is explained that compression-resistant materials in the form of powder sheets, powder fills, open-cell foams or glass-fiber materials are suitable for the core. In particular, insulating cores comprising powder sheets or loose powder are usually also enclosed in an air-permeable polyester nonwoven to reduce the formation of dust, as disclosed for example by DE 100 585 66 A1. This prevents dust from escaping during the evacuation operation in the vacuum chamber and prevents both the sealing seams and the vacuum chamber from becoming contaminated.

Core panels of microporous silica powder have a very fine pore structure and allow relatively high gas pressures without the thermal conductivity of the residual gas playing a part. Thus, in the case of these microporous materials, only a vacuum of 1 to 10 mbar is necessary to bring the thermal conductivity to 0.004 to 0.005 W/mK. Enclosures comprising special barrier films, which have only a wafer-thin, vapor-deposited coating of aluminum, ensure that the gas pressure in the core material only rises by about 1 mbar a year.

In the previously extensively explained prior art, various measures for producing vacuum insulation panels of the type in question are described. In particular, it is also explained that the sheet-like core may be not only of a one-part structure but also of a multi-part structure.

Comprehensive proposals are made for the configuration of the enclosure with the barrier films. Typically achievable gas permeabilities and water vapour permeabilities are described and proposals for the selection of materials for the barrier layers and the sealing layers are made.

All of the statements made in these respects in the prior art are also intended to apply correspondingly to the present invention, as long as they are not expressly contradictory to the statements made hereinafter. Consequently, for the relevant statements, reference is made to the full disclosure content of DE 10 2010 019 074 A1.

Vacuum insulation panels of the type in question have outstanding insulating properties. On account of the small thickness of the enclosure, however, vacuum insulation panels of the type in question are sensitive during handling. It must be ensured that the enclosure of the vacuum insulation panel is not damaged.

A detailed example of the structure of a vacuum insulation panel and the enclosure enclosing the core of such a panel is disclosed by U.S. Pat. No. 4,662,521 A. There, first a paper wrapper surrounding the core on all sides is provided. It is only on top of that that there is the enclosure enclosing the core. In the case of the example, it consists there of an inner sealing layer of polyethylene with a thickness of 50 μm, a gas-tight barrier layer of aluminum in a thickness of 9 μm and a top layer of polyester, located on the outside of the barrier layer, in a layer thickness of 12 μm. The enclosure consists of two sheet-like enclosure parts, which are placed with their sealing layers running around peripherally and are connected to one another in a gas-tight manner by sealing under pressure and temperature.

In the case of the known vacuum insulation panel on which the invention is based (DE 20 2014 002 192 U1), an additional protective measure for the barrier layer of the enclosure is taken by a layer of paper also being arranged on the outer side of the barrier layer or of an intermediate layer located on the outside of the barrier layer. The enclosure of that vacuum insulation panel has a greater stiffness than previously known enclosures at the place where the barrier layer or the intermediate layer located on the outside of the barrier layer, is combined with a layer of paper. This results in a lower sensitivity to mechanical damage and a smooth surface.

As far as the present invention is concerned, reference is made to the full disclosure of DE 20 2014 002 192 U1, in particular with regard to the structure of the enclosure and the possible variants for the form of the core.

For certain applications, for example in the construction industry or in vehicle construction, certain fire safety requirements have to be satisfied. Vacuum insulation panels according to the prior art explained above cannot meet high fire safety requirements of the relevant areas of use.

The teaching therefore addresses the problem of providing a vacuum insulation panel of the type in question that satisfies higher fire safety requirements than the previously described known vacuum insulation panels, in particular much higher fire safety requirements than there are for example in the automobile industry.

The object set out above is achieved in the case of a vacuum insulation panel with the features of the preamble of claim 1 by the features of the characterizing part of claim 1. Preferred configurations and developments are the subject of dependent claims 2 to 13.

According to the invention, a heat-resistant configuration of the enclosure of the vacuum insulation panel is not realized by a mixture of the material of an outer layer with heat-resistant and/or flame-retardant additives. Rather, an independent protective layer of a heat-resistant material is applied to the barrier layer or the intermediate layer located on the outside of the barrier layer. This is a special protective layer, which is optimized in terms of its fire preventing effect.

Apart from the heat-resistant protective layer to be additionally provided according to the invention, the variants that have specified in the previously extensively discussed prior art otherwise apply to the enclosure, so that reference can be made to the prior art as a whole.

Vacuum insulation panels of the type in question may have different forms. The standard form is a flat/panel-like design. Vacuum insulation panels are however also known in other forms, for example curved or angled or with different thicknesses in different portions. The present invention applies to all forms of vacuum insulation panels.

According to the invention, the heat-resistant protective layer is applied on the outside in at least one region of the outer surface of the vacuum insulation panel. Application of the protective layer on one side is sufficient in the case of a vacuum insulation panel that is fitted in a particular orientation. However, it is preferred that the complete enclosure is provided with the heat-resistant protective layer, so that it does not matter in which orientation the vacuum insulation panel according to the invention is fitted.

The heat-resistant protective layer may be applied to the barrier layer or the intermediate layer located on the outside of the barrier layer, by the material of the heat-resistant protective layer being applied in situ. However, because it results in better handling, it is preferred that the heat-resistant protective layer takes the form of a film that can be handled independently and is otherwise permanently connected to the enclosure by adhesive bonding.

Adhesive bonding in the context of the teaching of the present invention includes the use of additional adhesives, but also comprises the use of fusion adhesives, in particular hot-melt adhesives, or welding obtained by initial melting of the material of the heat-resistant protective layer and/or the barrier layer and/or the intermediate layer itself for the purpose of connecting them to one another. The use of a double-sided adhesive tape or an adhesive coating is also covered by this definition.

In a first particularly preferred embodiment, it is thus provided that the heat-resistant protective layer consists substantially of mica particles, in particular on the basis of phlogopite or muscovite, fixed with a binder. This is also referred to as “synthetic mica” (see for example Schröcke, Weiner “Mineralogie” [mineralogy], Walter de Gruyter, 1981, and German Wikipedia, under “Kunstglimmer” [synthetic mica]). In English-speaking countries, such mica-based materials are also referred to as “mica material” or “mica sheet” (English VVikipedia, under “mica” and also “phlogopite” and “muscovite”).

Layers substantially of mica particles fixed with a binder are already used in the prior art, for example as carrier material for heating wires or surface heating elements. In the present case they act differently, to be specific for protecting the material covered by them, for protecting the vacuum insulation panel as a whole.

In the context of optimized handling, to this extent a preferred embodiment is characterized in that the mica particles of the heat-resistant protective layer are applied and fixed on a sheet-like carrier material, in particular on a glass-fiber woven or knitted fabric or on a film of plastic, in particular a PET film. A glass-fiber woven or knitted fabric comes into consideration in particular as a carrier material for phlogopite, a PET film in particular for muscovite. In this way, the platelet-like mica particles with their binder can be handled well.

Synthetic resins of various provenance or synthetic rubber, which are known from the prior art (for example contact adhesives based on SBR styrene-butadiene rubber; for example the trade name “GLUKON”), primarily come into consideration as the binder.

In a preferred embodiment, the sheet-like carrier material is formed by the intermediate layer located on the barrier layer, in the case of a multi-ply configuration by the intermediate layer located on the outermost barrier layer. Consequently, the protective layer itself becomes an integral part of the enclosure itself.

In principle, the mica particles may be loosely laid on the sheet-like carrier material. Even in this phase of production of the vacuum insulation panel or an enclosure for a vacuum insulation panel, it may however be preferred already to pre-fix the mica particles by a binder, as previously described.

It is also recommendable in the end state that the mica particles on the sheet-like carrier material are covered and fixed by an outer protective layer, in particular of PET. The previously explained variants apply for the application of this protective layer.

In spite of the mica particles being used in the direct vicinity of a barrier layer, there are no problems with the stability of the vacuum insulation panels according to the invention, which is an entirely surprising result of this new development.

For the heat-resistant protective layer substantially of mica particles fixed with a binder, a thickness of the order of magnitude of 20 μm to 300 μm, preferably 50 μm to 150 μm, is recommendable. That is sufficient for the typical fire safety regulations of the present kind.

In an alternative, it may also be provided that the heat-resistant protective layer consists substantially of a material that expands when exposed to heat. A heat-insulating protective layer of this kind is also known from the prior art as a fireproof sheet (thermoplastic polyolefins, filled with inorganic flame retardant, for example alkali silicate, for example trade name “Cello HL Firestop R”).

In the case of the previously explained exemplary embodiment, greater thicknesses are required to achieve a corresponding fireproof effect, to be specific a thickness of about 0.5 mm to 5 mm, preferably of 2 mm to 3 mm.

The subject matter of the invention is also an enclosure film for vacuum insulation panels as such with the previously described properties, for which reference may be made to claims 14 to 17.

The invention is explained in more detail below on the basis of a drawing that merely represents exemplary embodiments. In the course of the explanation of the exemplary embodiments, particularly preferred variants and modifications of the teaching of the invention are also described.

### IN THE DRAWING

FIG. 1 shows in a schematic representation a first exemplary embodiment of a vacuum insulation panel according to the invention,

FIG. 2 shows in a schematic representation a second exemplary embodiment of a vacuum insulation panel according to the invention,

FIG. 3 shows in a schematic representation a third exemplary embodiment of a vacuum insulation panel according to the invention,

FIG. 4 shows in a schematic representation an exemplary embodiment of an enclosure film for vacuum insulation panels according to the invention,

FIG. 5 shows in a schematic representation a further exemplary embodiment of an enclosure film for vacuum insulation panels according to the invention.

In the figures, the dimensions are not to scale, but greatly exaggerated, to allow the structure to be explained well.

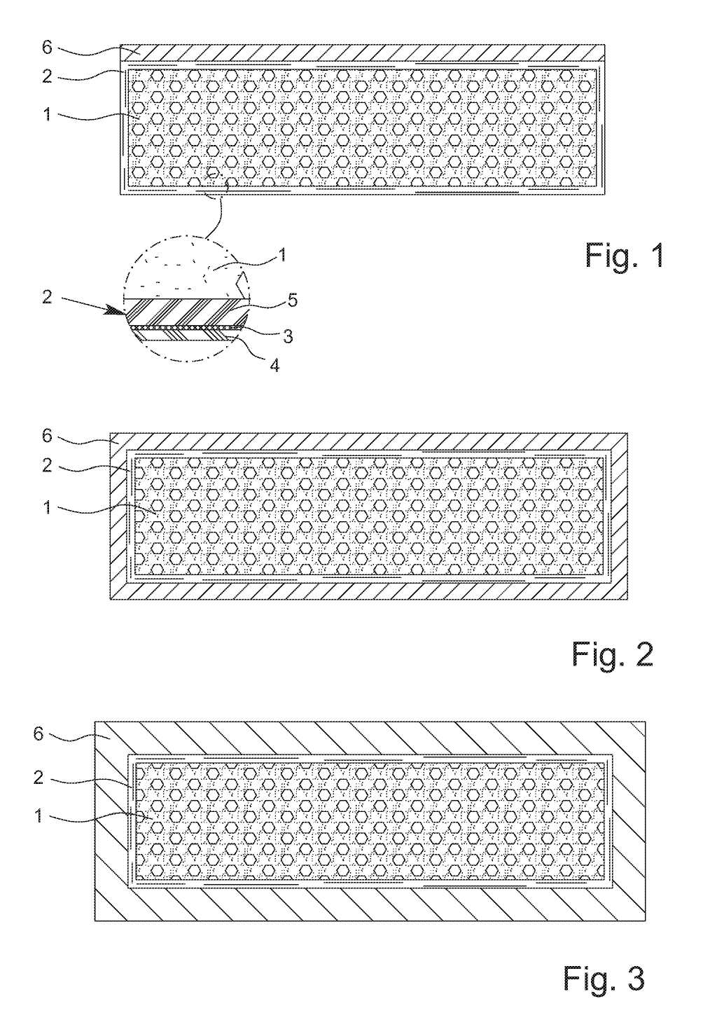

The first exemplary embodiment, represented in FIG. 1, shows a vacuum insulation panel with a core 1 of open-pore material and an enclosure 2 enclosing the core 1 in a close-fitting, complete and gas-tight manner on all sides. As can be seen from the detail in FIG. 1, which to this extent is also representative of the other figures, the enclosure 2 has at least one gas-tight barrier layer 3. In the exemplary embodiment that is represented and preferred, this consists of a thin metallization of aluminum, for example in the layer thickness known from the prior art of 5 μm to 10 μm. In the exemplary embodiment represented, an intermediate layer 4 of PET, in a thickness of for example 15 μm, can be seen on the outside of the barrier layer 3. In the exemplary embodiment represented, a sealing layer 5 of plastic, here in particular of polyethylene, in a thickness here of 50 μm, can also be seen on the inside of the barrier layer 3.

As has already been explained in relation to the prior art, the sealing layer 5 either abuts on the core 1 or between the sealing layer 5 and the core there is also a further intermediate layer, preferably of a plastics woven or knitted fabric or of paper, as has been mentioned above in relation to the prior art.

FIG. 1 shows a continuous enclosure 2, because it is a schematic representation. Very often, however, an enclosure 2 of two sheet-like enclosure parts or even of multiple enclosure parts, which are placed with their sealing layers running around peripherally and are connected to one another in a gas-tight manner by sealing, will be provided.

As far as the barrier layer 3 is concerned, reference is made to DE 20 2014 002 192 U1, which gives many examples of various structures of the barrier layer 3, which can also be used within the scope of the teaching of the invention. The same applies correspondingly to the structure described there of the enclosure 2 as a whole and also to the composition of the core 1, all of which can also be used within the scope of the teaching of the present invention.

In FIG. 1, it is therefore also indicated that the enclosure 2 also has in at least one region of the outer surface of the vacuum insulation panel a protective layer 6 of a heat-resistant material on the outside of the barrier layer 3 or on an intermediate layer 4 located on the outside of the barrier layer 3. In FIG. 1, this heat-resistant protective layer 6 can be seen on top of the vacuum insulation panel, that is to say on a main surface of the vacuum insulation panel.

In the case of the exemplary embodiment from FIG. 2, by contrast, it can be seen that here the complete enclosure 2 is provided with the heat-resistant protective layer 6.

It can be verified well from FIG. 1 that, according to the preferred teaching of the invention, it is particularly expedient technically in terms of handling that the heat-resistant protective layer 6 is configured as a sheet that can be handled independently and is otherwise permanently connected to the enclosure 2 by adhesive bonding. To this extent, with regard to the term “adhesive bonding”, reference may be made to the explanations that have been given in this regard in the introductory part of the description.

In the case of the exemplary embodiments of FIGS. 1 and 2, it is therefore specifically provided that the heat-resistant protective layer 6 consists substantially of mica particles, in particular on the basis of phlogopite or muscovite, fixed with a binder.

In principle, it would be conceivable that the heat-insulating protective layer 6 of mica particles is produced for example by the mica particles being scattered evenly onto the surface of the enclosure 1 provided with adhesive binder. That would be an application of the protective layer 6 as it were in situ.

The previously mentioned variant uses the intermediate layer 4 located on the barrier layer 3 or, in the case of a multi-ply configuration, the intermediate layer 4 located on the outermost barrier layer 3 as a sheet-like carrier material for the mica particles evenly distributed on it. These may be pre-fixed on the sheet-like carrier material as previously explained.

According to the preferred teaching, the mica particles located on the sheet-like carrier material are covered and fixed by an outer top layer 6′, this outer top layer 6′ preferably consisting of PET.

The variant already described in the general part of the description, with a sheet that can be independently handled, is also expedient. To this extent, it is provided with preference in the exemplary embodiments of FIG. 1 and FIG. 2 that the mica particles of the heat-resistant protective layer 6 are applied and fixed on a sheet-like carrier material, in particular on a glass-fiber woven or knitted fabric, in particular a PET film. Reference may be made to the explanations of this in the general part of the description.

As far as the preferred thickness of the protective layer 6 in the exemplary embodiments of FIGS. 1 and 2 is concerned, it is recommendable that the thickness of the heat-resistant protective layer 6 is between 20 μm and 300 μm, preferably between 50 μm and 150 μm.

FIG. 3 shows another exemplary embodiment of a vacuum insulation panel according to the invention in which specifically it is provided that the heat-resistant protective layer 6 consists substantially of a material that expands when exposed to heat. In this case, a preferred thickness of the protective film 6 is significantly greater than in the exemplary embodiments of FIGS. 1 and 2, to be specific is 0.5 mm to 5 mm, preferably 2 mm to 3 mm.

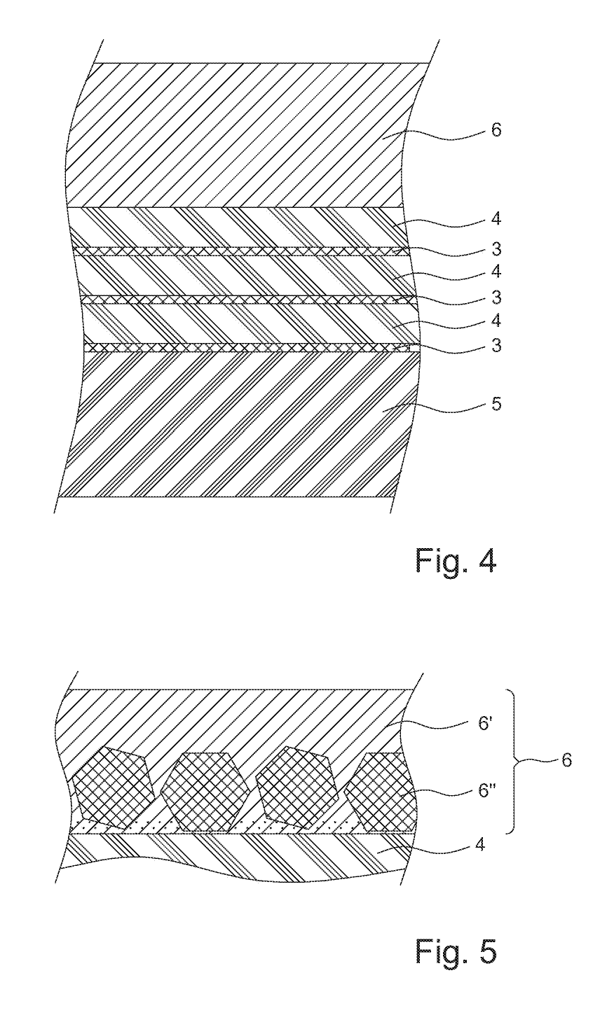

FIG. 4 shows an even more enlarged further special feature of the invention. FIG. 4 schematically shows the section through an enclosure film for vacuum insulation panels with a protective layer 6 of a heat-resistant material on the outside of the barrier layer 3 or on an intermediate layer 4 located on the outside of the barrier layer 3. In FIG. 4, it can be seen for the enclosure 2 that can be processed as a film that there is underneath first of all, as an example, a sealing layer 5 of polyethylene in a thickness of about 50 μm, over that the three-ply barrier layer 3, in each case with the combination of a metallization on a PET intermediate layer 4, each ply approximately in the thickness of 15 μm, and on that the protective layer 6, applied directly, of mica particles fixed with binder, the protective layer 6 having a thickness of about 50 μm. The entire enclosure film from FIG. 4 has a thickness of approximately 150 μm and comprises a sequence of layers that conforms to extremely high fire safety regulations. The enclosure film for vacuum insulation panels can then be used directly as enclosure 2 for vacuum insulation panels.

The exemplary embodiment represented in FIG. 5 shows a variant of the exemplary embodiment represented in FIG. 4. Here, the upper protective layer 6 of heat-resistant material is formed by mica particles 6″, which are located directly on the outermost intermediate layer 4 and here are pre-fixed with a binder, and an outer top layer 6′ of PET, which covers and fixes these mica particles 6″. In FIG. 5, for representational reasons only the upper region of the upper intermediate layer 4 is shown.

### LIST OF REFERENCE SIGNS

1 Core
2 Enclosure
3 Barrier layer
4 Intermediate layer
5 Sealing layer
6 Protective layer
6′ Top layer
6″ Mica particles

1. A vacuum insulation panel comprising:
a core of open-pore material; and
an enclosure enclosing the core in a close-fitting, complete and gas-tight manner on all sides,
the enclosure having at least one gas-tight barrier layer,
wherein
the enclosure has in at least one region of the outer surface of the vacuum insulation panel a protective layer of a heat-resistant material on the outside of the barrier layer or on an intermediate layer located on the outside of the barrier layer.

2. The vacuum insulation panel of claim 1, wherein
the enclosure has on the inner side of the barrier layer a sealing layer of plastic and the sealing layer abuts on the core or on at least one inner intermediate layer, the inner intermediate layer comprising a woven plastic or knitted fabric or paper.

3. The vacuum insulation panel of claim 1, wherein
the enclosure consists of two sheet-like enclosure parts, which are placed with their sealing layers running around peripherally, the two sheet-like enclosure parts connected to one another in a sealed, gas-tight configuration.

4. The vacuum insulation panel of claim 1, wherein
an entirety of the enclosure is provided with the heat-resistant protective layer.

5. The vacuum insulation panel of claim 1, wherein
the heat-resistant protective layer is a film that can be handled independently and is otherwise permanently connected to the enclosure by adhesive bonding.

6. The vacuum insulation panel of claim 1, wherein
the heat-resistant protective layer consists substantially of mica particles.

7. The vacuum insulation panel of claim 6, wherein
the mica particles of the heat-resistant protective layer are applied and fixed on a sheet-like carrier material, wherein the sheet-like carrier material is a woven glass-fiber or knitted fabric or a film of plastic, or a PET film.

8. The vacuum insulation panel of claim 7, wherein:
the sheet-like carrier material is formed by the intermediate layer located on the barrier layer, or
the sheet-like carrier material, in a multi-ply configuration, is formed by the intermediate layer located on the outermost barrier layer.

9. The vacuum insulation panel of claim 7, wherein
the mica particles are pre-fixed on the sheet-like carrier material with a binder.

10. The vacuum insulation panel of claim 7, wherein
the mica particles on the sheet-like carrier material are covered and fixed by an outer top layer.

11. The vacuum insulation panel of claim 6, wherein
the thickness of the heat-resistant protective layer is between 20 μm and 300 μm, or between 50 μm and 150 μm.

12. The vacuum insulation panel of claim 1, wherein
the heat-resistant protective layer consists substantially of a material that expands when exposed to heat.

13. The vacuum insulation panel of claim 12, wherein
the thickness of the expandable heat-resistant protective layer is between 0.5 mm and 5 mm, between 2 mm and 3 mm.

14. An enclosure film for vacuum insulation panels with at least one gas-tight barrier layer,
wherein
the enclosure film has a protective layer of a heat-resistant material on an outside of the barrier layer or on an intermediate layer located on the outside of the barrier layer.

15. The enclosure film of claim 14, wherein
the heat-resistant protective layer consists of mica particles which are applied and fixed directly to the barrier layer or to the intermediate layer located on the outside of the barrier layer.

16. The enclosure film of claim 15, wherein
the mica particles are fixed with a binder and/or are covered and fixed by an outer top layer, or a PET.

17. The enclosure film of claim 14, wherein
the heat-resistant protective layer consists substantially of a material that expands when exposed to heat, which is applied directly to and fixed to the barrier layer or the intermediate layer located on the outside of the barrier layer.

18. The vacuum insulation panel of claim 6, wherein
the heat-resistant protective layer consists substantially of mica particles on the basis of phlogopite or muscovite.

19. The enclosure film of claim 15, wherein
the heat-resistant protective layer consists substantially of mica particles on the basis of phlogopite or muscovite.
